(19) United States
(12) Patent Application Publication
(10) Pub. No.: US 2024/0222798 A1
(43) Pub. Date: Jul. 4, 2024

(54) CONNECTING UNIT FOR ELECTRICALLY CONTACTING AT LEAST TWO STORAGE CELLS, STORAGE UNIT, AND METHOD

(71) Applicant: NUMBAT GMBH, Kempten (Allgäu) (DE)

(72) Inventor: Maximilian WEGENER, Kempten (Allgäu) (DE)

(21) Appl. No.: 18/284,661

(22) PCT Filed: Apr. 4, 2022
(86) PCT No.: PCT/DE2022/100254

§ 371 Date: Sep. 28, 2023

(30) Foreign Application Priority Data
Apr. 6, 2021 (DE) 10 2021 108 519.5

(51) Int. Cl. H01M 50/503; H01M 50/505; H01M 50/514; H01M 50/521

(52) U.S. Cl. CPC H01M 50/503; H01M 50/505; H01M 50/514; H01M 50/521; H01M 2220/20

(57) ABSTRACT

The invention relates to a connection unit (10, 10′, 20, 20′, 30, 30′) for electrically contacting at least two storage cells (42-50′) for storing electrical energy, comprising a current-conducting connection body (12, 22, 32), at least two contact portions (14, 24, 34) configured to be connected to said storage cells (42-50′), wherein at least one of the two contact sections (14, 24, 34) has a predetermined breaking point (16, 26, 36) and/or wherein the connection unit (10, 10′, 20, 20′, 30, 30′) comprises at least one opening portion (28, 38, 39) which is arranged and configured such that at least a part of a contact portion remaining on a storage cell (42-50′) can project into the opening portion (28, 38, 39).

The invention relates to a connection unit for electrically contacting at least two storage cells for storing electrical energy, a first storage unit and a second storage unit for storing electrical energy, and methods for producing a first storage unit and a second storage unit.

Connection units for electrically contacting at least two storage cells are known in principle. Such connection units are also known as current collectors or busbars. Storage units, for example accumulators or batteries for electrically powered motor vehicles, typically comprise a plurality of storage cells connected to connection units. The storage cells can be battery cells, for example. A storage unit configured as a battery is, for example, an electrochemical energy storage unit.

During the useful life of such a storage unit, defects or wear typically occur in a plurality of the storage cells, so that their performance is reduced. These storage cells reduce the performance of the storage unit.

Storage units can be reconditioned by replacing storage cells with defects. A defect can also be understood as wear, which reduces the performance of the storage cell. One of the ways in which these storage cells are replaced is by removing at least one connection unit from the storage unit. However, removing the connection unit often results in the storage unit being damaged. Due to this, the connection units are usually removed from the individual storage cells with a high technical effort so that they remain intact even after the connection unit has been removed.

For most applications of such processed storage units, however, the effort mentioned in the preceding is not reasonable for economic reasons. Therefore, storage units with storage cells that have at least partially reduced performance are often used for a so-called second life cycle, in particular as electricity storage units. However, these electricity storage units have a low performance because the number of defective storage cells continues to increase over the service life. Such electricity storage devices are used, for example, as stationary electrical energy storage devices.

It is preferred that such storage units can also deliver a comparatively high electrical power, and thus the performance of such storage units is also increased in the second life cycle. In addition, the reprocessing process must be designed efficiently, since otherwise no economic use is possible in the second life cycle.

It is therefore an object of the invention to provide a connection unit for electrically contacting at least two storage cells for storing electrical energy, a first storage unit and a second storage unit for storing electrical energy, as well as methods for manufacturing a first storage unit and a second storage unit, which reduce or eliminate one or more of the aforementioned disadvantages. In particular, it is an object of the invention to provide a solution that improves the preparation of a storage unit for storing electrical energy.

According to a first aspect, this task is solved by a connection unit for electrically contacting at least two storage cells for storing electrical energy, comprising a current-conducting connection body, at least two contact portions configured for connection to the storage cells, wherein at least one of the two contact portions has a predetermined breaking point and/or wherein the connection unit comprises at least one opening portion arranged and configured such that at least a part of a contact portion remaining on a storage cell can project into the opening portion.

The connection of two storage cells by means of the connection unit described in the foregoing can be advantageously solved by removing the connection unit from the storage cells such that the connection unit breaks at the predetermined breaking point or points and thus a part of the connection unit remains on the storage cells. Surprisingly, the inventors have found that portions of the connection unit can remain on the storage cells without significantly complicating the fabrication of a second life cycle storage unit. The invention was further based on the realization that the long-held industry view that the connection unit should be completely removed from the storage cells is not applicable, since the remaining contact portion can be arranged in the opening portion or a contact portion of a second life cycle connection unit can be welded to the remaining contact portion.

The connection unit for electrically contacting at least two storage cells is configured in particular such that an electric current can flow from a first storage cell to a second storage cell when the connection unit is arranged as intended. For this purpose, the connection unit has in particular an electrically conductive material.

The connection unit comprises the current-conducting connection body, the at least two contact portions and at least one predetermined breaking point at one of the contact portions and/or the at least one opening portion. The connector body and the contact portions may be configured as a single piece. Furthermore, the connection body and the contact portions may be materially bonded to each other. Furthermore, the connection body and the contact portions may also be separate components that are electrically conductively connected to one another.

The contact portions are configured such that they can be electrically connected to storage cells for storing electrical energy. The contact portions are preferably configured such that a connection of the contact portion to the storage cells is weldable and/or solderable.

The connection unit preferably has a plurality of contact portions which are arranged adjacent to one another. In particular, it is preferred that the contact portions are arranged in a row. Conducting sections of these storage cells are also arranged adjacent to one another. The connection unit has contact portions corresponding to such conductive portions, so that the contact portions can be brought into connection with the conductive portions of the storage cells. Preferably, two, more or all contact portions have a predetermined breaking point.

For example, the contact portions of the connection unit may have a contact portion area of less than, equal to or more than 1 mm², more than 5 mm², more than 10 mm², more than 15 mm², more than 25 mm², more than 100 mm², more than 500 mm², more than 1000 mm² and/or more than 2000 mm².

The contact portions are preferably arranged and configured such that welding can be performed therethrough and a current-conducting connection can be formed by welding to an adjacent storage cell.

When the connection unit is removed from a storage unit, at least parts of the contact portions remain on the storage cells. These contact portions are hereinafter referred to as remaining contact portions. When these storage cells are contacted again with a connection unit, at least parts of the contact portions are located between the storage cells and the connection unit. Since the remaining contact portions are applied at different heights, their distal ends are usually not located in a connection plane. For example, the connection unit may rest on three or four contact portions remaining on the storage cells. The further storage cells and/or contact portions may be spaced from the connection unit, making it more difficult to make contact, for example with a welding process.

The connection unit with the opening portion solves this problem in that the spacing of the connection unit from the storage cells is not affected by the remaining contact portions in that they project into the opening portion. Thus, the connection unit can be arranged essentially flat against the storage cells, independent of remaining contact portions.

The opening portion may also be referred to as a clearance portion. The opening portion may be an opening enclosed on all sides. Alternatively, the opening may have one, two or more open sides. In particular, such an opening portion has a concave side, for example a mouth. The geometry of the opening portion preferably corresponds substantially to the geometry of the contact portions and/or the predetermined breaking point. The opening portion preferably has larger dimensions than the contact portions. In particular, it is preferred that a clearance fit can be formed between the opening portion and the contact portion. The contact portions are preferably arranged in a first row adjacent to each other and two or more opening portions are arranged in a second row adjacent to each other, so that preferably one contact portion and one opening portion are arranged adjacent to each other. Such an arrangement is also referred to as a paired arrangement of the contact portions and the opening portions.

It is further preferred that the connection unit comprises a first number of contact portions and a second number of opening portions, the first number corresponding to the second number. It is further preferred that the contact portions are arranged in a first arrangement pattern and the opening portions are arranged in a second arrangement pattern on the connector body, preferably the first arrangement pattern corresponding to the second arrangement pattern. The first and/or second arrangement pattern may be configured, for example, in a row-like and/or zigzag-like manner.

In a preferred embodiment of the connection unit, it is provided that the predetermined breaking point is configured such that when the connection unit is removed from the at least two storage cells, at least the contact portion with the predetermined breaking point is at least partially separated from the connection body and preferably remains on the storage cell. Separated substantially from the connection body means, in particular, that the contact portion remains at least partially or completely on the storage cell.

In a further preferred embodiment of the connection unit, it is provided that the predetermined breaking point is configured such that a predefined notch effect is produced when the connection unit is removed. Typically, the connection unit is removed mechanically from a first end or from a second end starting from the storage cells by applying force. Based on this, a notch effect can be predefined by a corresponding design of the predetermined breaking point. In particular, a notch effect is defined as a local stress concentration. For example, the predetermined breaking point can have a notch or be configured as a notch, with the notch causing the notch effect.

A further preferred embodiment of the connection unit is characterized in that the predetermined breaking point has a lower material thickness than the at least two contact portions and/or the connection body. It is preferred that the predetermined breaking point(s) and the at least two contact portions each have the same material thickness and the connection body has a greater material thickness. Such a material thickness gradient can form a predetermined breaking point.

Another preferred embodiment of the connection unit provides that the predetermined breaking point is configured as a laterally open slot. The laterally open slot preferably extends from a lateral edge of the connection body to the corresponding contact portion, so that a notch effect is produced when the connection unit is removed.

It is preferred that a ratio of the material thickness of the predetermined breaking point and a material thickness of the connection body is less than 0.8, less than 0.6, less than 0.4 and/or less than 0.2. In the case of a connection unit configured in such a way, the predetermined breaking point is configured, among other things, by a shoulder which is formed by the two different material thicknesses. The material thickness of the predetermined breaking point can, for example, be configured to be smaller than the material thickness of the connection body and/or the contact portions by means of material removal. The connection unit can be produced in such a way, for example, that material removal is performed on the connection body for each predetermined breaking point around a contact portion associated with the predetermined breaking point.

A further preferred further development of the connection unit is characterized by the fact that the predetermined breaking point is configured as a material weak point. The material weak point may be configured, for example, by a mechanical and/or chemical weakening of the material of the predetermined breaking point.

A further preferred embodiment of the connection unit is characterized in that the at least two contact portions and/or the connection body comprise a first material and the predetermined breaking point comprises a second material, the first material being configured differently from the second material.

In particular, it is preferred that the predetermined breaking point and the contact portions comprise the second material and the connection body comprises the first material. It is further preferred that the contact portions and the connector body comprise different materials. That the first material is configured differently from the second material may be enabled by one, two or more different properties of the first material and the second material. For example, the first material may have a greater hardness than the second material.

According to another preferred embodiment of the connection unit, it is provided that the predetermined breaking point comprises one, two or more openings, wherein preferably the opening or the two or more openings is configured as notch(s) and/or perforation(s). Furthermore, the predetermined breaking point may have a scribe track or be configured as a scribe track. Alternatively or additionally, it is preferred that the predetermined breaking point is configured as one, two or more openings, preferably the opening or openings being configured as notch or notches and/or as perforation or perforations.

The opening may be configured as a blind hole or a through hole. It is furthermore preferred that the predetermined breaking point has the opening or openings mentioned in the foregoing and furthermore has the different materials and/or different material thicknesses described in the foregoing.

It is particularly preferred that the at least one opening portion has a recess or is configured as a recess. The recess may, for example, be configured as a slit. The recess or recesses is or are preferably configured as a through opening or openings. In particular, it is preferred that the at least two contact portions and the at least one opening portion are dimensioned such that one of the contact portions can be arranged within the at least one opening portion.

According to a further aspect, the aforementioned task is solved by a first storage unit for storing electrical energy, in particular for an electrically driven vehicle and/or a power storage device, comprising at least two storage cells, a first connection unit according to one of the embodiments mentioned in the foregoing, wherein the at least two storage cells are electrically connected by means of the first connection unit.

The electrical connection between the at least two storage cells is configured in particular in that in each case one storage cell is electrically connected to a contact portion and the contact portions are likewise electrically connected by means of the current-conducting connection body. The storage cells preferably have conductive portions, one conductive portion in each case being connected to a contact portion of the connection unit. The conducting sections can, for example, be configured by poles of the storage cells or be poles of the storage cells. It is particularly preferred that the first storage unit has a plurality of storage cells and the first connection unit has a number of contact portions corresponding to the number of storage cells, so that a contact portion can preferably be arranged on each conductive portion.

It is preferred that the first storage unit is comprised as an electric energy storage unit of an electrically operated vehicle for providing a driving energy. Furthermore, the first storage unit may be comprised by a charging device for electrically operated vehicles or by a stationary storage unit.

According to a further aspect, the aforementioned task is solved by a second storage unit for storing electrical energy, in particular for an electricity storage device, comprising at least two storage cells, at least one of the storage cells having a remaining contact portion of a first connection unit, a second connection unit, in particular according to one of the embodiments described in the preceding, wherein an opening portion of the second connection unit is arranged such that the remaining contact portion projects into the opening portion, and/or wherein a contact portion of the second connection unit is connected to the remaining contact portion, preferably by material bonding, in particular by welding, and wherein the at least two storage cells are electrically connected by means of the second connection unit.

The second connection unit preferably comprises a current-conducting connection body, at least two contact portions configured for connection to the storage cells, wherein at least one of the two contact portions has a predetermined breaking point and/or wherein the connection unit comprises at least one opening portion, which is arranged and configured such that at least a part of the contact portion remaining on the storage cell can project into the opening portion.

The second storage unit is preferably based on the first storage unit. For example, the at least two storage cells of the second storage unit may be storage cells that were already included in a first storage unit. Furthermore, one, two or more storage cells with reduced performance of the first storage unit may be replaced by more powerful storage cells. The fact that one of the storage cells comprises a contact portion of a first connection unit may be due to the fact that these storage cells were connected to each other with a first connection unit and the connection unit was removed from the storage cells such that when the connection unit was removed from the at least two storage cells, the contact portions were substantially separated from the connection body and remained on the storage cells.

A storage unit configured in such a manner can be advantageously manufactured. In particular, by being able to arrange and contact the second connection unit substantially planar on the storage cells reduces the manufacturing cost.

In particular, that at least one of the storage cells comprises a contact portion of a first connection unit means that at least one of the storage cells comprises at least part of the contact portion of the first connection unit.

It is preferred that the second storage unit is comprised by a charging device for electrically powered vehicles.

The second storage unit can also be a third, fourth or further storage unit, wherein at least one of the storage cells has two, three or more remaining contact portions of first, second and/or further connection units, which has a third, fourth or further connection unit, in particular according to one of the embodiments described in the foregoing, wherein opening portions at the remaining contact portions are arranged such, that the remaining contact portions project into the opening portions, and/or wherein contact portions of the third, fourth or further connection unit are materially bonded, in particular by welding, to one or more of the remaining contact portions, and wherein the at least two storage cells are electrically connected by means of the third, fourth or further connection unit.

According to a further aspect, the task mentioned at the outset is solved by a method for producing a first storage unit, in particular a first storage unit according to one of the embodiments described in the foregoing, comprising the steps: Providing at least two storage cells for storing electrical energy and a first connection unit for electrically contacting the at least two storage cells, in particular a connection unit according to one of the embodiments mentioned in the preceding, and electrically connecting the two storage cells to the first connection unit.

The first connection unit comprises a current-conducting connection body and at least two contact portions configured for connection to the storage cells. Further, at least one of the contact portions has a predetermined breaking point.

The electrical connection may be made, for example, by a welding process, in particular a laser welding process, or a soldering process.

According to a further aspect, the task mentioned at the outset is solved by a method for producing a second storage unit, in particular a second storage unit according to one of the embodiments described in the foregoing, comprising the steps: providing a first storage unit, in particular a first storage unit according to one of the embodiments described in the preceding; removing the first connection unit such that at least one of the contact portions of the first connection unit remains at least in sections on one of the storage cells, preferably the at least one remaining contact portion being separated from the connection body at the predetermined breaking point; contacting the storage cells by means of a second connection unit, in particular a connection unit according to one of the embodiments described in the foregoing, having at least two contact portions which are configured for connection to the storage cells; wherein the remaining contact portion projects into the opening portion and/or wherein at least one of the contact portions of the second connection unit is connected to the remaining contact portion, preferably by material bonding, in particular by welding.

The method described in the foregoing can also be used to manufacture a third, fourth or further storage unit, wherein the opening portion can also have two or more recesses for receiving a plurality of contact portions per storage cell.

In a preferred embodiment, the method comprises the step of: replacing one, two or more of the storage cells of the first storage unit. In particular, the one, two or more storage cells are replaced with storage cells having a higher performance. Preferably, the storage cells to be replaced have a reduced performance capability. It is therefore further preferred that the method comprises the step of: Detection of storage cells with a reduced performance capability. A reduced performance is characterized in particular by a drop in performance compared to a full performance of more than 20%, more than 30%, more than 40% and/or more than 50%. The manufactured second storage unit preferably comprises storage cells already included in the first storage unit and additional storage cells replacing storage cells with a low performance of the first storage unit.

The methods and their possible further embodiments have features or method steps that make them particularly suitable for being used for a connection unit, a first storage unit and/or a second storage unit.

For further advantages, embodiment variants and embodiment details of the further aspects and their possible further embodiments, reference is also made to the previously given description regarding the corresponding features and further embodiments of the connection unit.

Preferred embodiments are explained by way of example with reference to the accompanying figures. They show:

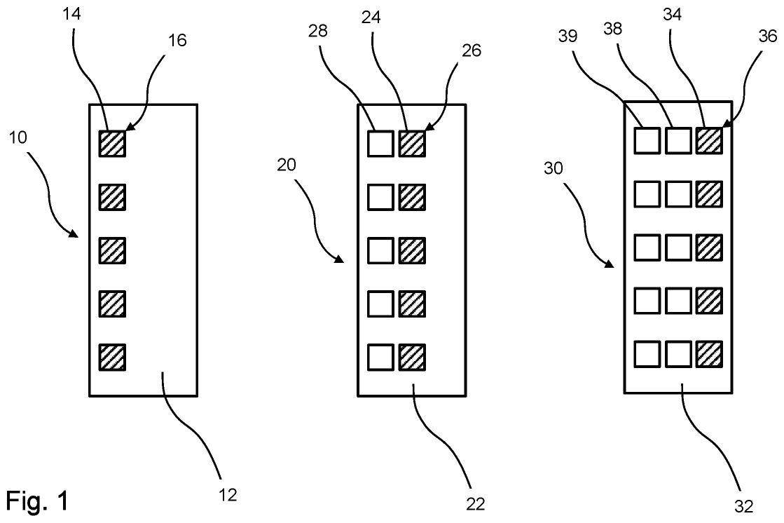

FIG. 1: schematic views of exemplary embodiments of connection units;

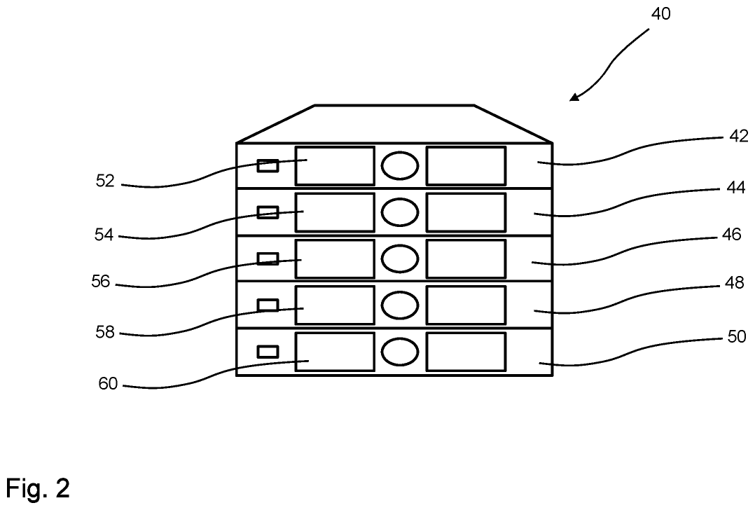

FIG. 2: a schematic view of an exemplary embodiment of adjacently arranged storage cells;

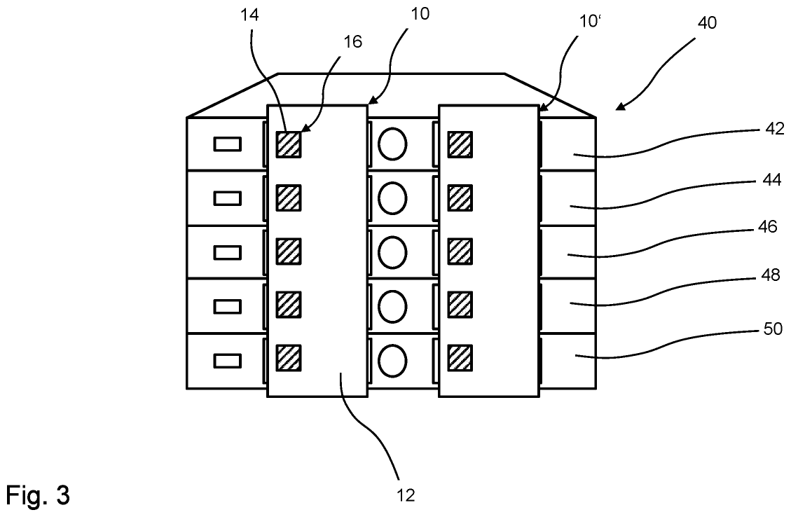

FIG. 3: a schematic view of an exemplary embodiment of a first storage unit;

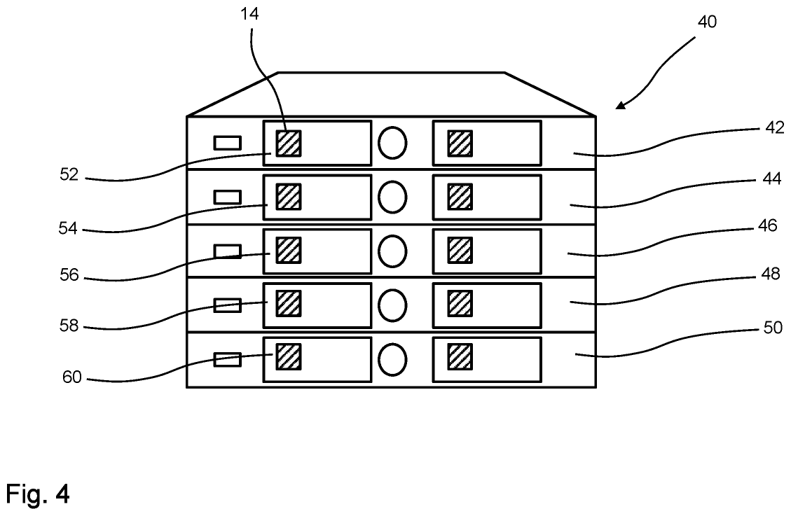

FIG. 4: a schematic view of the first storage unit shown in FIG. 3 with the first connection units removed;

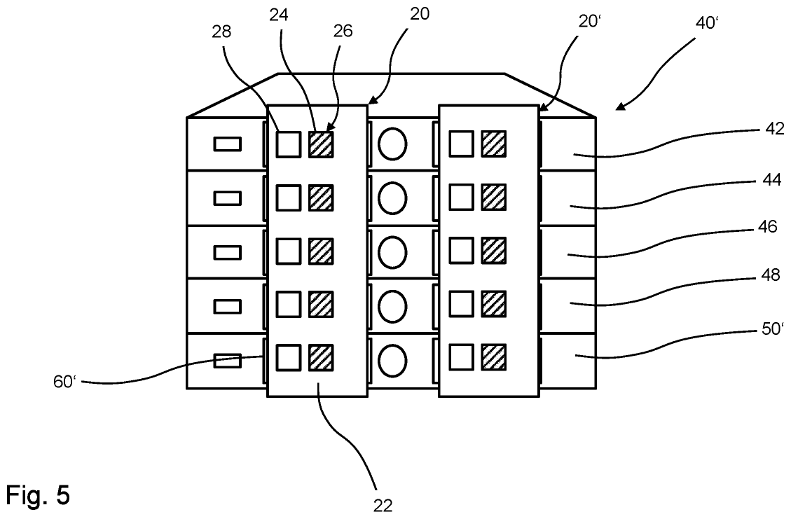

FIG. 5: a schematic view of an exemplary embodiment of a second storage unit;

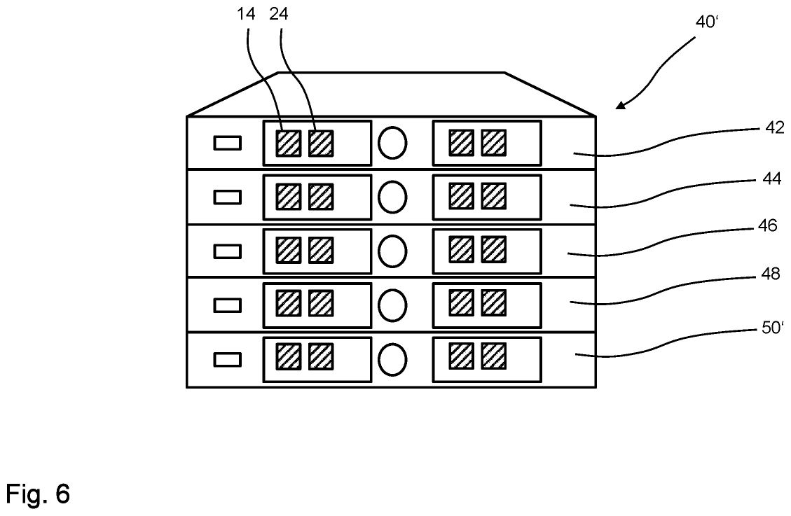

FIG. 6: a schematic view of the second storage unit shown in FIG. 5 with second connection units removed;

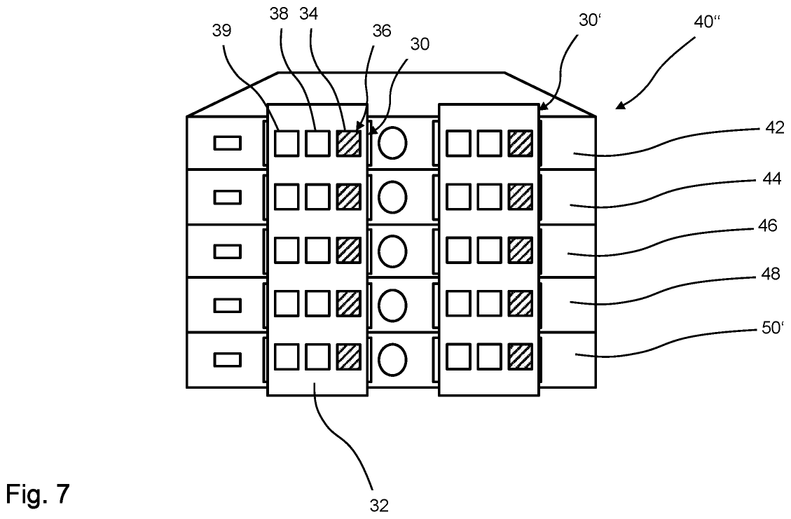

FIG. 7: a schematic view of an exemplary embodiment of a third storage unit;

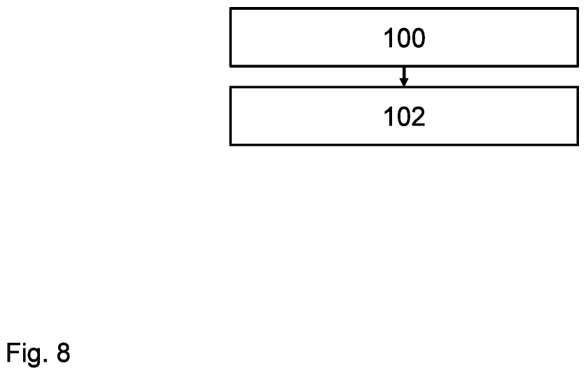

FIG. 8: a schematic first method;

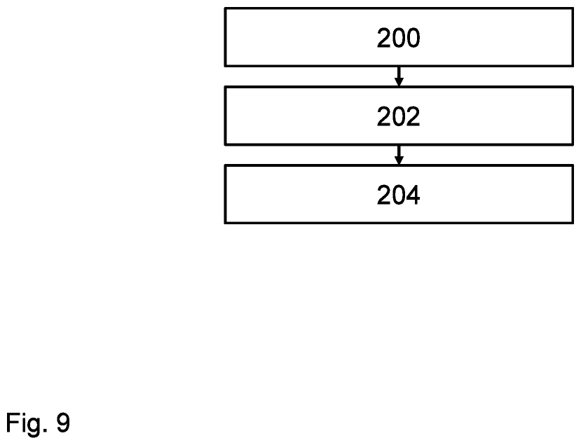

FIG. 9: a schematic second method; and

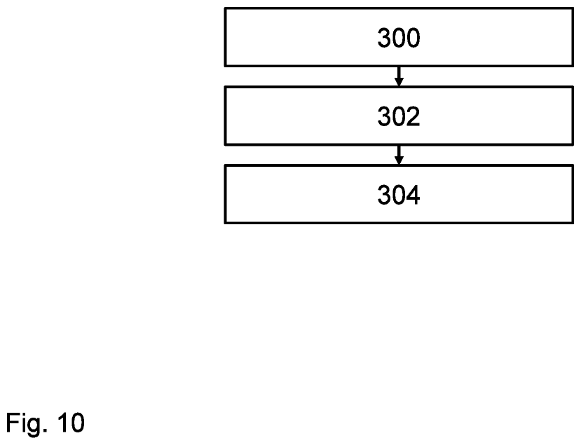

FIG. 10: a schematic third method.

In the figures, identical or substantially functionally identical or similar elements are designated with the same reference signs.

FIG. 1 shows a first connection unit 10. The first connection unit 10 comprises a connection body 12 and five contact portions 14, of which only one contact portion is provided with the reference sign 14. The contact portions 14 each have a predetermined breaking point 16. The predetermined breaking point 16 may, for example, enclose the contact portion 14 so that the geometry of the predetermined breaking point 16 is configured as a square. The predetermined breaking points 16 may, for example, each be configured as a perforation on the outer periphery of the contact portions 14. Furthermore, the predetermined breaking point 16 and/or the contact portion 14 may have a lower material thickness than the connection body 12 and/or a different material than the connection body 12.

FIG. 1 further illustrates a second connection unit 20 having a connection body 22. The second connection unit 20 includes five second contact portions 24. The second contact portions 24 each include a predetermined breaking point 26. The second connector unit 20 further includes five opening portions 28. The opening portions 28 and the second contact portions 24 are each arranged in pairs, such that an opening portion 28 is arranged adjacent to each second contact portion 24. The opening portions 28 are arranged substantially at the position where the contact portions 14 are arranged on the first connection unit 10.

By such an arrangement, an improved storage unit with respect to a used storage unit can be provided by means of the second connection unit 20. In the case where the first connection unit 10 is removed from the storage cells of a storage unit, the contact portions 14 are removed from the connection body 12 by means of the predetermined breaking points 16 at least in sections, i.e. partially. The contact portions 14 remain on the storage cells at least in sections. In the case where the second connection unit 20 is arranged on these storage cells, the remaining contact portions 14 can project into the opening portions 28, so that the second connection unit 20 can be arranged substantially flat on the storage cells.

Alternatively, another first connection unit 10, 10′ may be arranged on the storage cells and the first contact portions 14 are welded to the remaining contact portions and/or the storage cells.

Furthermore, a third connection unit 30 is shown in FIG. 1, which can be used for a third life cycle of a storage unit. The third connection unit also has a connection body 32, third contact portions 34, and predetermined breaking points 36, respectively. The third connection unit further comprises two opening portions 38, 39, each of which is disposed adjacent a third contact portion 34.

As soon as the second connection unit 20 is removed from a storage unit, the second contact portions 24 remain on the storage cells analogously to the first connection unit 10. By means of the opening portions 38, 39 of the third connection unit 30, it is thus possible for the third connection unit to be arranged flat on the storage cells and for it to be brought into contact with conductive portions of the storage cells, so that contacting of the storage cells with the third connection unit is advantageously made possible.

FIG. 2 shows five storage cells 42-50 arranged one above the other. Each of the storage cells 42-50 comprises two guide sections 52-60, wherein only one of the guide sections 52-60 of a storage cell is provided with a reference sign.

FIG. 3 shows a storage unit 40 comprising the storage cells 42-50 shown in FIG. 2 and two first connection units 10, 10′. The storage cells 42-50 are electrically connected by means of the first connection units 10, 10′. For this purpose, the connection units 10, 10′ are positioned such that in each case a contact portion 14 is arranged one of the conductive portions 52-60. A permanent connection can be configured, for example, by welding the contact portions 14 to the conductive portions 52-60. Such a storage unit 40 may be used, for example, in an electrically operated vehicle.

FIG. 4 shows the storage unit 40 shown in the foregoing with the first connection units 10, 10′ removed. It can be seen that the contact portions 14 have remained on the conductive portions 52-60. The first connection units 10, 10′ have been removed, for example, by the application of mechanical force, whereby the predetermined breaking points 16 of the contact portions 14 have caused the contact portions 14 to remain on the conducting portions 52-60.

FIG. 5 shows a second storage unit 40′, wherein the storage cell 50 has been replaced by a storage cell 50′ of higher performance with two conductive sections 60′, since the storage cell 50 had a reduced performance. The storage cells 42-50′ are electrically connected to each other with second connection units 20, 20′. It can be seen that opening portions 28 of the connection units 20, 20′ are arranged where the contact portions 14 remained. The contact portions 14 are basically visible through the opening portions 28. For clarity, this detail has not been shown. The storage cells 42-50′ are respectively connected at their conductive portions 52-60′ to the second contact portions 24. Such a second storage unit 40′ can be used, for example, as a power storage unit, in particular in a charging device, for example a charging column, for electric vehicles.

FIG. 6 shows the second storage unit 40′, whereby the connection units 20, 20′ have been removed and, analogous to the first storage unit 40, only the second contact portions 24 and the contact portions 14 are arranged on the conducting portions 52-60′.

FIG. 7 shows a third storage unit 40″ on which two third connection units 30, 30′ are arranged. The contact portions 14, 24 remaining on the storage cells 42-50′ project into the opening portions 38, 39 of the connection body 32. The connection units 30, 30′ electrically connect the storage cells 42-50′ by means of the third contact portions 34 and the connection body 32. The third contact portions 34 of the third connection units 30, 30′ furthermore each have a predetermined breaking point 36. The third contact portions 34 can alternatively be configured without the predetermined breaking point, in particular if removal of the third connection units 30. 30′ is not intended. This can apply analogously to the second connection units 20, 20′ if the second connection units 20, 20′ are not to be removed from the storage cells.

The storage units 40, 40′, 40″ shown in the foregoing enable particularly advantageously manufacturable and powerful power storage units that can be used in a wide variety of applications. In particular, in contrast to the prior art, a third life cycle of an electricity storage unit is made possible, which was not economically producible under previously known aspects.

FIG. 8 shows a schematic method for manufacturing a first storage unit. In step 100, at least two storage cells 42-50 for storing electrical energy and a first connection unit 10, 10′ for electrically contacting the at least two storage cells 42-50 are provided. In step 102, the at least two storage cells 42-50 are connected to the first connection unit 10, 10′.

FIG. 9 shows a method for manufacturing a second storage unit 40′. In step 200, a first storage unit 40 is provided. In step 202, the first connection unit 10, 10′ is removed such that at least one of the contact portions 14 of the first connection unit 10, 10′ remains at least partially attached to one of the storage cells 42-50, wherein the at least one contact portion 14 is separated from the connection body 12 at the predetermined breaking point 16.

In step 204, the storage cells 42-50 are contacted by means of a second connection unit 20, 20′. The second connection unit 20, 20′ comprises second contact portions 24 configured to connect to the storage cells 42-50.

The contacting of the storage cells 42-50 is performed such that at least one opening portion 28 of the second connection unit 20, 20′ acts on the at least one contact portion 14 such that at least a part of a contact portion 14 remaining on a storage cell 42-50 can project into the opening portion 28.

Alternatively, the contacting may be performed by a material bonding of the second contact portions 24 of the connection unit 20, 20′ to the remaining first contact portions 14.

The step 202 may further comprise the sub-step of replacing one, two or more of the storage cells 42-50, for example with a replacement storage cell 50′. Thus, the performance of the second storage unit 40′ is increased.

FIG. 10 illustrates a method of manufacturing a storage unit 40″ in a further life cycle, which could be, for example, the third or fourth life cycle. In step 300, a second storage unit 40′ is provided. In step 302, the second connection units 20, 20′ are removed such that at least one of the second contact portions 24 of the second connection units 20, 20′ remains at least partially on one of the storage cells 42-50′, preferably separating the at least one second contact portion 24 from the connection body 22 at the predetermined breaking point 26. In step 304, the storage cells 42-50′ are contacted by means of a third connection unit 30, 30′.

In particular, the contacting is performed such that at least a first opening portion 38 of the third connection unit 30, 30′ acts on the at least one contact portion 14 and a second opening portion 39 of the third connection unit 30, 30′ acts on the at least one second contact portion 24 such that the remaining contact portions 14, 24 project into the opening portions 38, 39.

With the methods described in the foregoing, storage units 40, 40′, 40″ can be recycled or reused in a particularly efficient manner. In particular, removal of the connection units 10, 10′, 20, 20′, 30, 30′ is possible with little effort, since the predetermined breaking points 16, 26, 36 allow parts of the connection units 10, 10′, 20, 20′, 30, 30′ to remain on the storage cells 42-50′. Furthermore, the storage units 40′, 40″ can be manufactured in a particularly advantageous manner, since remaining contact portions 14, 24 do not have to be removed and no spacing between storage cells 42-50′ and connection units 20, 20′, 30, 30′ has to be bridged during contacting.

REFERENCE SIGNS

| | |
|---|---|
| 10, 10′ | first connection unit |
| 12 | connection body |
| 14 | contact portion |
| 16 | predetermined breaking point |
| 20, 20′ | second connection unit |
| 22 | connection body |
| 24 | second contact portion |
| 26 | predetermined breaking point |
| 28 | opening portion |
| 30, 30′ | third connection unit |
| 32 | connection body |
| 34 | third contact portion |
| 36 | predetermined breaking point |
| 38 | opening portion |
| 39 | opening portion |
| 40, 40′, 40″ | storage unit |
| 42 | storage cell |
| 44 | storage cell |
| 46 | storage cell |
| 48 | storage cell |
| 50, 50′ | storage cell |
| 52 | guide section |
| 54 | guide section |
| 56 | guide section |
| 58 | guide section |
| 60 | guide section |

1. Connection unit for electrically contacting at least two storage cells for storing electrical energy, comprising
a current-conducting connection body,
at least two contact portions configured to be connected to said storage cells,
wherein at least one of the two contact portions has a predetermined breaking point and/or wherein the connection unit comprises at least one opening portion which is arranged and configured such that at least a part of a contact portion remaining on a storage cell can project into the opening portion.

2. Connection unit according to claim 1, wherein the predetermined breaking point is configured such that when the connection unit is removed from the at least two storage cells, at least the contact portion with the predetermined breaking point is at least partially separated from the connection body and remains on the storage cell.

3. Connection unit according to claim 1, wherein the predetermined breaking point is configured such that a predefined notch effect is produced when the connection unit is removed.

4. Connection unit according to claim 1, wherein the predetermined breaking point has a smaller material thickness than the at least two contact portions and/or the connection body.

5. Connection unit according to claim 1, wherein
the at least two contact portions and/or the connection body comprise a first material, and
the predetermined breaking point comprising a second material,
the first material is configured differently from the second material.

6. Connection unit according to claim 1, wherein the predetermined breaking point comprises one, two or more openings, the opening or the two or more openings being configured as notch or notches and/or as perforation or perforations.

7. Connection unit according to claim 1, wherein the at least one opening portion has a recess or is configured as a recess, which is configured as a through opening.

8. Connection unit according to claim 1, wherein the at least two contact portions and the at least one opening portion are dimensioned such that one of the contact portions can be arranged within the at least one opening portion.

9. First storage unit for storing electrical energy for an electrically driven vehicle and/or an electricity storage device, comprising
at least two storage cells,
a first connection unit according to claim 1,
wherein the at least two storage cells are electrically connected by means of the first connection unit.

10. Second storage unit for storing electrical energy for an electricity storage system, comprising
at least two storage cells, at least one of the storage cells having a remaining contact portion of a first connection unit,
a second connection unit according to claim 1, wherein an opening portion of the second connection unit is arranged such that the remaining contact portion projects into the opening portion, and/or wherein a contact portion of the second connection unit is connected to the remaining contact portion by material bonding, and
wherein the at least two storage cells are electrically connected by means of the second connection unit.

11. Method for manufacturing a first storage unit, comprising the steps:
Providing at least two storage cells for storing electrical energy and a first connection unit according to claim 1 for electrically contacting the at least two storage cells; and
electrically connecting the at least two storage cells to the first connection unit.

12. Method for manufacturing a second storage unit, comprising the steps:
Providing a first storage unit comprising at least two storage cells, and a first connection unit according to claim 1, wherein the at least two storage cells are electrically connected by means of the first connection unit;
Removing the first connection unit such that at least one of the contact portions of the first connection unit remains at least in sections on one of the storage cells, the at least one remaining contact portion being separated from the connection body at the predetermined breaking point;
Contacting the storage cells by means of a second connection unit according to claim 1, having at least two contact portions configured for connection to the storage cells;
wherein the remaining contact portion projects into the opening portion and/or wherein at least one of the contact portions of the second connection unit is connected to the remaining contact portion by material bonding.

13. Method according to claim 12, comprising the step of: Replacing one, two or more of the storage cells of the first storage unit.
